(19) United States
(12) Patent Application Publication
(10) Pub. No.: US 2008/0268840 A1
(43) Pub. Date: Oct. 30, 2008

(54) Apparatus and Method for Controlling a Radio Bearer Reconfiguration

(75) Inventor: Paul McDonald, Swindon (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/908,536

(22) PCT Filed: Mar. 6, 2006
(86) PCT No.: PCT/US06/07764

§ 371 Date: Sep. 13, 2007

(30) Foreign Application Priority Data
Mar. 31, 2005 (GB) 0506537.0

(51) Int. Cl. H04Q 7/20

(52) U.S. Cl. 455/435.1

(57) ABSTRACT

An apparatus for controlling a radio bearer reconfiguration in a cellular communication system, such as a UMTS communication system, comprises a reconfiguration instigator (301) which initiates a radio bearer reconfiguration for a radio bearer supporting a communication between a base station (105) and a user equipment (107). Rather than using a static worst case estimate, a reconfiguration switch time processor (309) determines a reconfiguration switch time in response to a dynamic parameter of the radio bearer reconfiguration process. In particular, the radio parameter may be a size of a radio bearer configuration message transmitted to the user equipment (107). The reconfiguration switch time is transmitted to the base station by a base station communication processor (311) and to the user equipment (107) by a UE communication processor (313). The base station (105) and the user equipment (107) reconfigure their circuitry to apply the reconfigured parameters from the reconfiguration switch time.

### FIELD OF THE INVENTION

The invention relates to an apparatus and method for controlling a radio bearer reconfiguration and in particular to controlling radio bearer reconfiguration in a cellular communication system.

### BACKGROUND OF THE INVENTION

Currently, the most ubiquitous cellular communication system is the 2^{nd} generation communication system known as the Global System for Mobile communication (GSM) which uses a technology known as Time Division Multiple Access (TDMA). Further description of the GSM TDMA communication system can be found in ‘The GSM System for Mobile Communications’ by Michel Mouly and Marie Bernadette Pautet, Bay Foreign Language Books, 1992, ISBN 2950719007 or in the Technical Specifications standardised by the European Telecommunication Standards Institute (ETSI).

To further enhance the services and performance of the GSM communication system, a number of enhancements and additions have been introduced to the GSM communication system over the years.

One such enhancement is the General Packet Radio System (GPRS), which is a system developed for enabling packet data based communication in a GSM communication system. Thus, the GPRS system is compatible with the GSM (voice) system and provides a number of additional services, including provision of packet data communication, which augments and complements the circuit switched communication of a traditional communication system.

Currently, 3^{rd} generation systems are being rolled out to further enhance the communication services provided to mobile users. The most widely adopted 3^{rd} generation communication systems are based on Code Division Multiple Access (CDMA). An example of a communication system using this principle is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876 or in the Technical Specifications issued by the 3^{rd} Generation Partnership Project.

Whereas GSM originally was used almost exclusively for circuit switched voice services, cellular communication systems are now designed to provide a large number of different services including packet data services and high data rate services. For example, UMTS has been designed to provide a number of different services with very different characteristics and providing different Quality of Service parameters. For example, an Internet browsing application may be supported by a packet data service having a variable delay and throughput whereas a streaming application may be supported by a packet data service having a relatively constant average throughput and low delay.

In order to support such varying services, UMTS provides for different radio bearers to be configured to provide the desired characteristics. A radio bearer may typically be considered to be a physical communication channel provided over the air interface and having specified characteristics. In particular, a radio bearer may be used to support transmission of data over the air interface with a given Quality of Service characteristic.

Furthermore, a given User Equipment (UE) may provide a number of different services or support different applications and these may be supported by a plurality of radio bearers being set up for a given UE.

The service requirement for a UE may change dynamically and UMTS therefore provide for reconfiguration of radio bearers allowing these to be optimised for the UE's current requirements.

Such reconfiguration may be provided relatively frequently such as for example when:
adding a bearer communications channel (RAB—Radio Access Bearer) to a physical radio channel that has a pre-existing signalling channel (SRB);
modifying the data rate of a RAB, e.g. to match the current throughput of traffic over that RAB.

In UMTS, reconfiguration of an existing radio bearer is controlled by a Radio Network Controller (RNC). Specifically, the RNC transmits messages to the UE and base station (known as a Node B for UMTS) defining the radio bearer parameters that should be applied following the reconfiguration. In addition, the RNC transmits messages that indicate when the reconfiguration is taking place. In particular, the RNC informs the UE and base station of a frame number from which the air interface should adopt the new configuration. Thus, when the frame number is reached, the base station and UE both switch from the previous configuration and proceed to communicate using the parameters for the reconfigured radio bearer. This allows a coordinated switch-over from the old to the new air-interface encoding.

In order to ensure that the base station and UE are ready to apply the newly reconfigured parameters, the RNC conventionally selects a frame number which is sufficient to ensure that both the base station and the UE has received the reconfiguration messages comprising the reconfiguration parameters. However, the reconfiguration messages are typically relatively large (typically up to 3000 bytes) and the communication channel for the UE typically has a relatively low data rate (typically 3.4 kbps) resulting in a large worst case delay. Accordingly, the reconfiguration switch over is frequently delayed by more than a second. This large delay is disadvantageous and may be noticeable to a user in many applications. For example, a telephony call will encounter this reconfiguration delay before call setup can complete. In a mobile-to-mobile telephony call, the user may experience delays of several seconds because of these reconfigurations occurring at both ends.

If the value of the reconfiguration time is not set to be long enough, there is a danger that the selected frame number will have passed before the UE and base station have had sufficient time to reconfigure themselves. In UMTS, this results in the reconfiguration pausing until that frame number is repeated in its cycle, a delay of over 2 seconds.

Hence, an improved system for reconfiguration of radio bearers would be advantageous and in particular a system allowing increased flexibility, improved performance, an improved user experience and/or a reduced reconfiguration delay would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for controlling a radio bearer reconfiguration in a cellular communication system, the apparatus comprising: means for initiating a radio bearer reconfiguration for a radio bearer supporting a communication between a base station and a user equipment; determining means for determining a reconfiguration switch time in response to a dynamic parameter of the radio bearer reconfiguration process; means for communicating the reconfiguration switch time to the user equipment; and means for communicating the reconfiguration switch time to the base station.

The invention may allow an improved radio bearer reconfiguration for a cellular communication system. In particular a more accurate reconfiguration switch time may be determined. The reconfiguration delay may be reduced significantly and an improved user experience may be achieved in many embodiments.

The base station and the user equipment may switch to use reconfigured radio parameters from the reconfiguration switch time. As the reconfiguration switch time is determined in response to a dynamic parameter of the radio bearer reconfiguration process, a more accurate estimate of when the base station and the user equipment may be ready to switch to a new configuration may achieved. Thus, the need for a worst case reconfiguration switch time to be used is avoided resulting in improved reconfiguration performance.

A dynamic parameter of the radio bearer reconfiguration process is a parameter which may vary between radio bearer reconfigurations. Thus, the dynamic parameter may be one that may change between different radio bearer reconfiguration process rather than a constant parameter.

The radio bearer reconfiguration may correspond to a creation, modification or termination of a radio bearer configuration.

According to an optional feature of the invention, the dynamic parameter is a message size of a radio bearer configuration message. This may provide particularly advantageous performance and may allow a high degree of adaptation to the characteristics of the current reconfiguration process. In particular, the transmission of a radio bearer configuration message may typically be the main source of variability of the delay before a user equipment or base station is ready for a new configuration.

According to an optional feature of the invention, the radio bearer configuration message is a radio bearer configuration message transmitted to the user equipment. This may provide particularly advantageous performance and allow a high degree of adaptation to the characteristics of the current reconfiguration process. In particular, the transmission of radio bearer configuration message to the user equipment is typically the main source of variability of the delay before a reconfiguration can be applied.

In some embodiments, the radio bearer configuration message may be a radio bearer configuration message which is transmitted to the base station.

According to an optional feature of the invention, the radio bearer configuration message is a configuration data message comprising radio bearer parameters.

The radio bearer configuration message may specifically comprise the reconfiguration parameters indicating which parameters should be applied following the radio configuration. Typically, the size of the radio bearer configuration message comprising such information is substantial and varies significantly. Accordingly, the variability of the delay before a reconfiguration can be applied may depend highly on the size of such a radio bearer configuration message.

According to an optional feature of the invention, the determining means is arranged to determine the reconfiguration switch time in response to an acknowledgement delay for the radio bearer configuration message.

This may allow a more accurate determination of an appropriate reconfiguration switch time.

According to an optional feature of the invention, the determining means is arranged to determine the reconfiguration switch time in response to a fixed delay offset.

This may allow a more accurate determination of an appropriate reconfiguration switch time and/or may allow a low complexity implementation. The offset may for example provide a practical way of accounting for known and relatively constant delays associated with the reconfiguration process. Alternatively or additionally, the offset may provide a practical means of introducing an error margin to the determination of the reconfiguration switch time.

Optionally, the determining means may be arranged to determine the reconfiguration switch time in response to a user equipment abort time interval. Specifically, the fixed delay offset may be set to include a delay allowing the user equipment to return an abort message that terminates the process. For example, in a UMTS system, the fixed delay offset may include a delay to allow a user equipment to return a potential Radio Bearer Setup Failure message.

According to an optional feature of the invention, the apparatus is arranged to receive an external command and to set the offset in response to the external command. This may facilitate operation and allow an improved customisation. The external command may for example be received from an Operations and Maintenance Centre (OMC).

According to an optional feature of the invention, the dynamic parameter comprises a throughput characteristic of a communication channel for the radio bearer configuration message. This may provide particularly advantageous performance and allow a high degree of adaptation to the characteristics of the current reconfiguration process. In particular, the throughput may substantially affect the delay before a user equipment or base station is ready for a new configuration.

According to an optional feature of the invention, the throughput characteristic comprises an error rate of a communication channel for a configuration message. This may allow improved performance and a more accurate determination of the reconfiguration switch time.

According to an optional feature of the invention, the throughput characteristic comprises a data rate of a communication channel for a configuration message. This may allow improved performance and a more accurate determination of the reconfiguration switch time.

According to an optional feature of the invention, the message size is scaled in response to the throughout characteristic. This may allow improved performance and a more accurate determination of the reconfiguration switch time and/or may facilitate implementation.

According to an optional feature of the invention, the reconfiguration switch time indicates a frame number. This may improve performance and/or facilitate implementation. The frame number may be a frame number of the radio bearer or may in some embodiments be a frame number of another radio bearer or communication channel such as a communication channel used to communicate the reconfiguration messages to the user equipment.

According to an optional feature of the invention, the determining means is arranged to estimate a delay in response to the dynamic parameter. This provides a practical means of determining the reconfiguration switch time.

According to an optional feature of the invention, the reconfiguration switch time is indicative of a time at which reconfiguration parameters are to be applied to the communication.

According to an optional feature of the invention, the cellular communication system is a 3^{rd} Generation cellular communication system. In particular, the radio bearer may be a Universal Mobile Telecommunication System (UMTS) Terrestrial Radio Access Network (UTRAN) radio bearer.

The apparatus may be implemented in a Radio Network Controller (RNC).

According to a second aspect of the invention, there is provided a method of controlling a radio bearer reconfiguration in a cellular communication system, the method comprising: initiating a radio bearer reconfiguration for a radio bearer supporting a communication between a base station and a user equipment; determining a reconfiguration switch time in response to a dynamic parameter of the radio bearer reconfiguration process; communicating the reconfiguration switch time to the user equipment; and communicating the reconfiguration switch time to the base station.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a UMTS cellular communication system comprising a Radio Network Controller (RNC) in accordance with some embodiments of the invention;

FIG. 2 illustrates an example of a signalling flow in connection with a radio bearer reconfiguration;

FIG. 3 illustrates a configuration controller in accordance with some embodiments of the invention; and

FIG. 4 illustrates method of controlling a radio bearer reconfiguration in a cellular communication system in accordance with some embodiments of the invention.

### DETAILED DESCRIPTION OF EMBODIMENTS OF THE INVENTION

The following description focuses on embodiments of the invention applied to a Radio Network Controller of a 3^{rd} Generation cellular communication system and in particular a Universal Mobile Telecommunication System (UMTS). However, it will be appreciated that the invention is not limited to this application but may be applied to many other network elements and cellular communication systems.

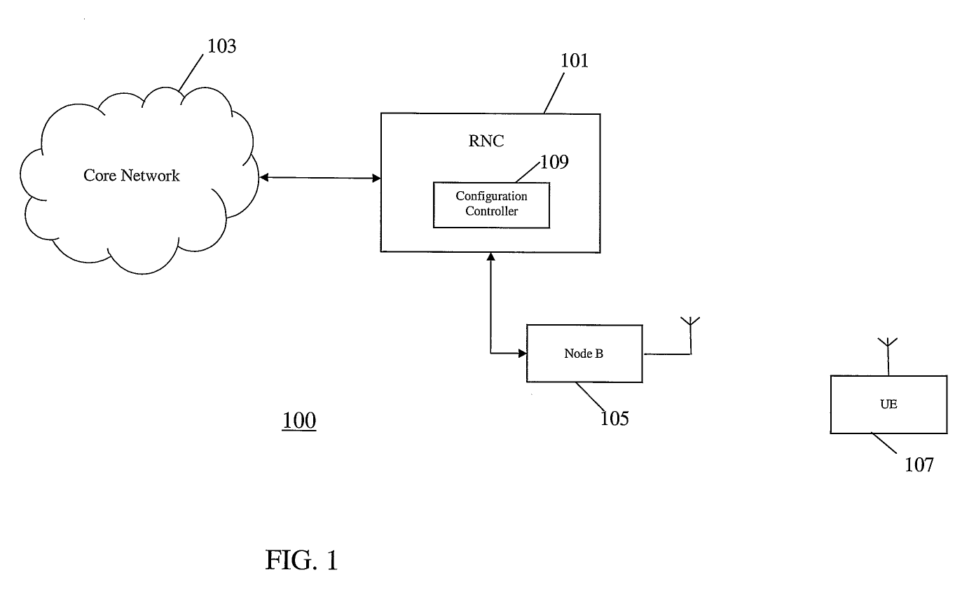

FIG. 1 illustrates a UMTS cellular communication system 100 comprising a Radio Network Controller (RNC) 101 in accordance with some embodiments of the invention.

The cellular communication system 100 comprises a core network 103 and a UMTS Terrestrial Radio Access Network (UTRAN) comprising RNCs and base stations. The core network is operable to route data from one part of the RAN to another and to interface with other communication systems. In addition, it performs many of the operation and management functions of a cellular communication system, such as billing. The RAN is operable to support wireless user equipment over a radio link being part of the air interface. The wireless user equipment may be a mobile station, a communication terminal, a personal digital assistant, a laptop computer, an embedded communication processor or any communication element communicating over the air interface. The RAN comprises the base stations, which in UMTS are known as Node Bs, as well as Radio Network Controllers (RNC) which control the Node Bs and the communication over the air interface.

FIG. 1 shows one RNC 101 of the RAN. The RNC 101 is coupled to the core network 103 and to a base station 105. The RNC 101 may furthermore be connected to a plurality of other base stations (not shown).

The base station 105 supports communication over the air interface and in particularly supports communication with a user equipment (UE) 107. The communication services provided to the UE 107 by the cellular communication system are supported by radio bearers of the air interface and in particular the RNC 101 controls the configuration of one or more radio bearers supporting communication channels between the base station 105 and the UE 107. Accordingly, the RNC 101 comprises a Configuration controller 109 which controls the configuration of the radio bearers over the physical air-interface radio link to the UE.

In order to flexibly and efficiently support variations in the communication requirements for the UE 107, the radio link may be reconfigured when convenient. Such reconfiguration may comprise creation, modification or termination of radio bearers and may specifically comprise a reconfiguration of the radio parameters of one or more radio bearers. Such radio parameters may include: Transport Format Set, Power, Code, Timing Adjustment, Transport Layer Address, Slot Format, TFCI, and the fact that a Radio Bearer is being added, deleted or modified in the physical Radio Link.

When configuring a radio bearer, the configuration process takes a certain amount of time and it is necessary to ensure that both the base station 105 and the UE 107 is ready to support the new configuration before this is activated. Accordingly, the RNC 101 communicates a frame number from which time the new configuration parameters should be adopted. This allows a coordinated switch-over from the old to the new air-interface encoding. However, in order to ensure that the base station 105 and UE 107 are ready, a worst case duration for the configuration setup process is conventionally assumed resulting in a large delay.

More specifically, the RNC 101 will inform the UE 107 of when the switch-over should occur by transmitting an RB_Setup or RB_Reconfig message as defined by the UMTS Technical Specifications. The RNC 101 will furthermore inform the base station 105 separately using the UMTS RL_Reconfig_Commit message.

Conventionally, an RNC selects a frame number which is sufficiently far in the future to perform this switch-over reliably. The frame number must be selected sufficiently far enough into the future for the following actions to be completed:
The RB_Setup message must be sent to a UE using the appropriate Signalling Radio Bearer (SRB). The SRB is relatively slow resulting in a significant delay.
The UE must decode the RB_Setup message and prepare the air-interface communication functionality for the switch-over.
The RL_Reconfig_Commit message must be sent to the base station serving the UE.
The base station must decode the RL_Reconfig_Commit message and prepare the air-interface communication functionality for the switch-over.

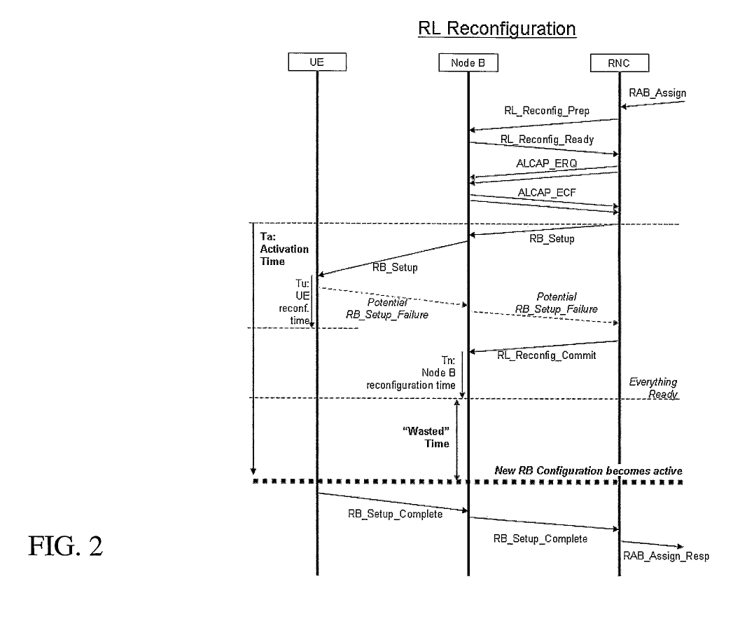

FIG. 2 illustrates an example of a signalling flow in connection with a radio bearer reconfiguration.

In the example, the switch time is selected at the beginning of the procedure and included in the RB_Setup message communicated to a UE. When the last frame of this message has been acknowledged back to the RNC, the RNC proceeds to send the RB_Reconfig_Commit to the serving base station. Only after reconfiguration has occurred does the UE terminate the procedure with an RB_Setup_Complete message.

The switch time is conventionally selected to account for the worst case scenario of a slow UE , slow signalling link (SRB) and potential errors in RLC frames resulting in retransmission. As such, the switch time might be typically set to around 60 Transmit Time Intervals (TTIs) into the future. For a 20 ms frame structure, this results in a delay of 1.2 s which is a very substantial delay in any signalling procedure. Thus, the reconfiguration time is a very significant source of delays for many events such as for a voice or data call setup.

As the delay is conventionally based on a worst case assumption, it is typically too large for the majority cases.

For a typical example the following parameters may used:
A UE requires 2 TTIs to reconfigure itself.
A base station requires 2 TTIs to reconfigure itself.
There are no air-interface errors
Signalling transmission delay between the base station and the corresponding RNC is negligible.
20 ms bearer TTI interval

The following delay estimates may be obtained for signalling messages of different sizes using a 3.4 kbit/s SRB:

| RLB Setup Message Size | 500 | 1500 | 3000 | bits |
|---|---|---|---|---|
| UE Ready after: | 200 | 520 | 1000 | ms |
| NodeB Ready after: | 240 | 560 | 1040 | ms |
| Traditional Activation: | 1200 | 1200 | 1200 | ms |
| Wasted time | 960 | 640 | 160 | ms |

Thus, the switch time is conventionally set to around 1.2 s as this is required for RB_Setups of large size. As the message size decreases, the amount of wasted time is increased. A typical RB_Setup message size is 1500 bits (although this varies greatly).

For a 13.4 kbit/s SRB, the 1.2 s activation time is even more wasteful:

| RLB Setup Message Size | 500 | 1500 | 3000 | bits |
|---|---|---|---|---|
| UE Ready after: | 80 | 160 | 280 | ms |
| NodeB Ready after: | 90 | 170 | 290 | ms |
| Traditional Activation: | 1200 | 1200 | 1200 | ms |
| Wasted time | 1110 | 1030 | 910 | ms |

A key observation is that the time required to activate is significantly dependent on the message size. In an air-interface environment with a significant error rate, the effect is even more pronounced and a larger delay than the 1200 ms may be required.

In the example of FIG. 1, the configuration controller is arranged to determine the reconfiguration switch time in response to a dynamic parameter of the radio bearer reconfiguration process. This may allow a more accurate determination of when the base station 105 and UE 107 are ready for the switch over. Accordingly, a variable delay which depends on the actual conditions for the specific configuration may be achieved resulting in a substantial reduction of the wasted time and a substantial reduction of the total delay of the configuration.

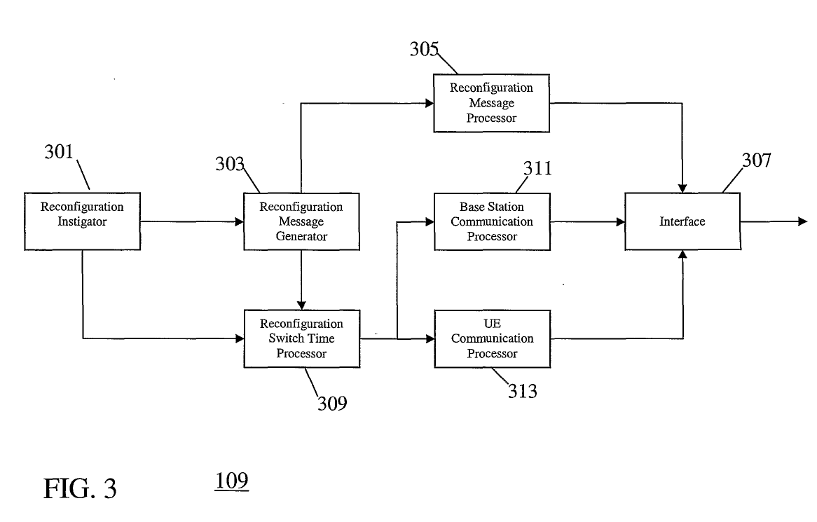

FIG. 3 illustrates a block diagram of the configuration controller 109 of FIG. 1.

The configuration controller 109 comprises a reconfiguration instigator 301 which is operable to initiate a radio bearer reconfiguration for a radio bearer supporting the communication between the base station 105 and the UE 107. The reconfiguration may for example comprise setting up a new radio bearer, terminating an existing radio bearer or changing parameters used by an existing radio bearer.

The reconfiguration instigator 301 may instigate the reconfiguration in response to a change in the service requirement for the UE 107. For example, the UE may request that a new voice call is set up or that the Quality of Service parameters are modified for an ongoing service.

The reconfiguration instigator 301 is coupled to a reconfiguration message generator 303 and when the reconfiguration instigator 301 determines that a radio bearer reconfiguration should be initiated a control signal is fed to the message generator 303.

In response, the message generator 303 proceeds to generate one or more reconfiguration messages. In the specific example, the message generator 303 generates a radio bearer configuration message for the UE 107 in the form of an RB_Setup or RB_Reconfig message and a separate radio bearer configuration message for the base station 105 in the form of a UMTS RL_Reconfig_Commit message.

The radio bearer configuration message comprises the radio parameters for all the radio bearers within UE 107's physical radio link and may for example indicate the Transport Format Set, Power, Code, Slot Format etc which is to be applied to the individual radio bearers following the reconfiguration.

The message generator 303 is coupled to a reconfiguration message processor 305 which is operable to transmit the radio bearer configuration messages to the base station 105 and UE 107 respectfully. The reconfiguration message processor 305 is coupled to an Interface 307 which provides an interface function for an Iub connection to the base station 105. Thus, the reconfiguration message processor 305 transmits the radio bearer configuration messages to the base station 105 through the interface 307. The radio bearer configuration message for the UE 107 is then forwarded to the UE 107 over the signalling radio bearer (SRB).

The reconfiguration instigator 301 is furthermore coupled to a reconfiguration switch time processor 309 which is operable to determine a reconfiguration switch time in response to a dynamic parameter of the radio bearer reconfiguration process. Thus, when the reconfiguration instigator 301 instigates a radio bearer reconfiguration the reconfiguration switch time processor 309 proceeds to determine the reconfiguration switch time from which the base station 105 and the UE 107 should apply the new configuration.

The reconfiguration switch time processor 309 is coupled to a base station communication processor 311 which is operable to generate a message indicating the reconfiguration switch time and to communicate this to the base station 105. The base station communication processor 311 is coupled to the interface 307 and transmits the message comprising the reconfiguration switch time over the Iub interface.

Similarly, the reconfiguration switch time processor 309 is coupled to a UE communication processor 313 which is operable to generate a message indicating the reconfiguration switch time and to communicate this to the UE 107. The base station communication processor 311 is coupled to the interface 307 and transmits the message comprising the reconfiguration switch time to the base station 105 over the Iub interface. The base station 105 then transmits the message to the UE 107 over the SRB.

In the example of FIG. 3, the reconfiguration switch time processor 309 is coupled to the message generator 303 and determines the reconfiguration switch time in response to message size of a radio bearer configuration message. In particular, the message generator 303 feeds information of the size of the radio bearer configuration message for the UE 107 to the reconfiguration switch time processor 309 which determines the reconfiguration switch time in response to this.

As illustrated previously, the delay of transmitting the radio bearer configuration message to the UE 107 over the relatively slow SRB is typically the largest source of the overall delay of the reconfiguration process. Furthermore, the size of the radio bearer configuration message may vary significantly between different reconfigurations and therefore may result in a large variation of the delay. Accordingly, by taking the dynamic parameter of the size of the radio bearer configuration message to the UE 107 into account, a significantly more accurate reconfiguration switch time may be determined resulting in a reduced overall delay.

In the example of FIG. 1, the reconfiguration switch time processor 309 estimates the time it takes for the radio bearer configuration message to be transmitted to the UE 107 and a total expected delay is determined by adding fixed delays associated with some or all of the other actions of the reconfiguration process.

As a specific example, the reconfiguration switch time processor 309 may determine the reconfiguration switch time by estimating the time it takes to transmit the RB_Setup message to the UE 107.

The size of the RB_Setup message is received from the message generator 303 and in response the number of transport blocks that are required for transmitting the RB_Setup message on the SRB is determined. In order to take into account the time taken to acknowledge the message, a block is added to the total number of blocks. The time for transmitting the message is then determined by multiplying the block number by the block duration.

A fixed delay offset may be added to the estimated delay in order to take into account other delays which vary less and to introduce a safety margin.

The fixed delay offset may for example be received from an external source and may in particular be an OMC settable parameter. This may allow a central optimisation and may allow the network operator to conveniently control the performance and error margin for radio bearer reconfigurations.

The fixed delay can include the delay that would be expected if the UE rejected the RB Setup request with a RB Setup Fail message. This message typically has a length with limited variability and thus the potential delay could be estimated by the reconfiguration switch time processor 309 and added to the other computed delays.

The calculated delay is then used to determine a frame number for the radio bearers. In some embodiments, all radio bearers may be frame synchronised and a common frame number for the reconfiguration switch time may be determined. In such a case, or in situations where the reconfiguration switch time frame number is a frame number of the SRB, the calculation of the delay may be performed in terms of transmit frames.

In some embodiments, the radio bearers may not be frame synchronised and in particular the reconfigured radio bearer may have different frame numbers and possible frame durations than the SRB. In such, cases the reconfiguration switch time may be determined in terms of the frame number of the reconfigured radio bearer.

The reconfiguration switch time frame number is then transmitted to the base station 105 and the UE 107 which proceed to apply the reconfiguration parameters from this frame number.

Thus, the reconfiguration switch time may be determined in response to a dynamic parameter which may vary between different radio bearer reconfigurations. This may provide substantially reduced reconfiguration delay in comparison to a conventional static worst case calculation.

The determination of the reconfiguration switch time may be in response to a throughput of a communication channel for the radio bearer configuration message. In particular, the data rate of the SRB may be taken into account when determining the number of required SRB blocks for the transmission of the RB_Setup message.

In some embodiments, the error rate of the SRB may alternatively or additionally be taken into account. Specifically, although the previous example allows an improved performance, the margin tends to be required to be fairly substantial in order to allow for errors and retransmissions of blocks of the RB_Setup message on the SRB.

Therefore, in many embodiments it may be advantageous to take the estimated error rate on the SRB into account. This may practically be achieved by scaling the determined size of the RB_Setup message in response to the error rate of the SRB.

The error rate may for example be estimated based on the number of retransmissions on the SRB or may be set manually, for example by an external command from the OMC.

As another example, the error target of the SRB is a parameter that is configured for that radio channel and which the CDMA power control procedures attempt to maintain in practice. Thus this preset error rate parameter for the SRB may be used as the expected error rate.

As a specific example, the reconfiguration switch time may be determined from the following approach:

Compensated RB_Setup message size=Roundup(RB_Setup message size* (1+SRB Error Rate))

SRB Blocks required=(Compensated RB_Setup message size/RLC_PDU_size+1)*SRB_TTI_int

Reconfiguration Switch Time=SRB Blocks required/bearer_TTI_int+F

where F is a fixed delay offset providing a safety margin and reflecting other potential delays, SRB_TTI_int is the transmit time interval for the signalling radio bearer and bearer_TTI_int is the transmit time interval for the radio bearer being reconfigured. A typical value for F may be 10.

As an example, for a 3.4 kbit/s SRB and a 20% RLC PDU error rate, the above described approach results in the following reconfiguration switch times:

| RLB Setup Message Size | 500 | 1500 | 3000 | bits |
|---|---|---|---|---|
| UE ready after | 240 | 640 | 1200 | ms |
| Base station ready after: | 280 | 680 | 1240 | ms |
| Traditional Activation: | 1200 | 1200 | 1200 | ms |
| New Algorithm | 400 | 800 | 1360 | ms |
| Wasted time | 120 | 120 | 120 | ms |

Thus, in the example, the average unnecessary delay time is 120 ms compared to a typical 640 ms of the traditional approach.

For a 13.4 kbit/s SRB, with 20% RLC PDU errors, the following results are obtained:

| RLB Setup Message Size | 500 | 1500 | 3000 | bits |
|---|---|---|---|---|
| UE ready after | 90 | 190 | 330 | ms |
| Base station ready after: | 100 | 200 | 340 | ms |
| Traditional Activation: | 1200 | 1200 | 1200 | ms |
| New Algorithm | 250 | 350 | 490 | ms |
| Wasted time | 150 | 150 | 150 | ms |

In this case, for all message sizes, the unnecessary delay time is 150 ms compared to a typical 1000 ms of the traditional approach.

As illustrated, a significantly improved reconfiguration is achieved with a substantially reduced delay before the application of the reconfigured parameters. For example, in the case of the 13.6 kbit/s SRB, the reconfiguration procedure delay could be reduced from 1.2 s to 0.35 s. In a mobile-to-mobile telephony call setup, this change could reduce call setup delay by around 1.5 s which results in a substantially improved user experience.

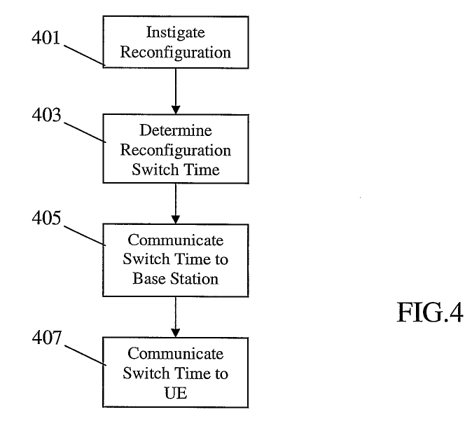

FIG. 4 illustrates method of controlling a radio bearer reconfiguration in a cellular communication system in accordance with some embodiments of the invention. The method may be applied to the configuration controller 109 of FIG. 1 and will be described with reference to this.

In step 401, the method initiates by the reconfiguration instigator 301 initiating a radio bearer reconfiguration for a radio bearer supporting a communication between the base station 105 and the UE 107.

Step 401 is followed by step 403 wherein the reconfiguration switch time processor 309 determines a reconfiguration switch time in response to a dynamic parameter of the radio bearer reconfiguration process.

Step 403 is followed by step 405 wherein the base station communication processor 311 communicates the reconfiguration switch time to the UE 107.

Step 405 is followed by step 407 wherein the UE communication processor 313 communicates the reconfiguration switch time to the base station.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor.

Furthermore, the term reconfiguration is considered to be equivalent to the term configuration and may as such include configuration of a new radio bearer or configuration of an existing radio bearer including setting up, tearing down or modifying a radio bearer. As such, in the specific example of a UMTS system, the same RL Reconfiguration procedure may result in the generation of RB Setup, RB Reconfiguration or RB Release messages being sent on the air interface. It will be appreciated that the operation described previously may applies to any of these processes.

Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An apparatus for controlling a radio bearer reconfiguration in a cellular communication system, the apparatus comprising:
means for initiating a radio bearer reconfiguration for a radio bearer supporting a communication between a base station and a user equipment;
determining means for determining a reconfiguration switch time in response to a dynamic parameter of the radio bearer reconfiguration process;
means for communicating the reconfiguration switch time to the user equipment; and
means for communicating the reconfiguration switch time to the base station.

2. The apparatus of claim 1 wherein the dynamic parameter is a message size of a radio bearer configuration message, including radio bearer parameters, transmitted to the user equipment.

3. The apparatus of claim 2 wherein the determining means is arranged to determine the reconfiguration switch time in response to one of the group of an acknowledgement delay for the radio bearer configuration message and a fixed delay offset.

4. The apparatus of claim 3 wherein the apparatus is arranged to receive an external command and to set the fixed delay offset in response to the external command.

5. The apparatus of claim 1 wherein the dynamic parameter comprises a throughput characteristic of a communication channel for the radio bearer configuration message.

6. The apparatus of claim 5 wherein the throughput characteristic comprises one of the group of an error rate and a data rate of a communication channel for a configuration message.

7. The apparatus of any claim 6 wherein the message size is scaled in response to the throughout characteristic

8. The apparatus of claim 1 wherein the reconfiguration switch time is indicative of one of the group of a frame number and a time at which reconfiguration parameters is to be applied to the communication.

9. The apparatus of claim 1 wherein the determining means is arranged to estimate a delay in response to the dynamic parameter.

10. A method of controlling a radio bearer reconfiguration in a cellular communication system, the method comprising:
initiating a radio bearer reconfiguration for a radio bearer supporting a communication between a base station and a user equipment;
determining a reconfiguration switch time in response to a dynamic parameter of the radio bearer reconfiguration process;
communicating the reconfiguration switch time to the user equipment; and
communicating the reconfiguration switch time to the base station.
